(19) United States
(12) Patent Application Publication
(10) Pub. No.: US 2023/0416071 A1
(43) Pub. Date: Dec. 28, 2023

(54) BEVERAGE STATION

(71) Applicant: Starbucks Corporation, Seattle, WA (US)

(72) Inventors: Travis W. Cline, Greenacres, FL (US); Susan P. Behroozi, Seattle, WA (US); Erik S. Anderson, Mercer Island, WA (US); Joshua J. Kruger, Seattle, WA (US); John F. Park, Seattle, WA (US); Jeffrey L. Jessie, Snohomish, WA (US); Raegan T. Powell, Seattle, WA (US); Lynnea M. Paddock, Shoreline, WA (US); Joseph E. Gormley, Mercer Island, WA (US); Zander J. Hall-Spicuzza, Mountlake Terrace, WA (US)

(21) Appl. No.: 18/338,867

(22) Filed: Jun. 21, 2023

Related U.S. Application Data
(60) Provisional application No. 63/355,240, filed on Jun. 24, 2022.

(51) Int. Cl. B67D 1/06

(52) U.S. Cl. CPC B67D 1/06; B67D 2001/0095

(57) ABSTRACT

A beverage station including a first zone, a second zone, and a third zone. The first zone can be positioned below a countertop. The second zone can be positioned at a level of the countertop. The third zone can be positioned at an overhead level, the third zone comprising at least one reduced temperature zone.

### CROSS-REFERENCE TO RELATED APPLICATION(S)

This application claims the benefit of U.S. Provisional Application No. 63/355,240, filed Jun. 24, 2022, which is hereby incorporated by reference herein in its entirety.

### FIELD

The present disclosure relates to systems and methods for preparing beverages, such as, systems and methods for preparing cold beverages in a beverage station.

### BACKGROUND

Beverages at a coffee store can include a large number of ingredients that can be combined in various ways and at various doses for various drinks. Conventionally, in response to receiving a beverage order, a barista creates the beverage by manually retrieving ingredients from their respective containers and bringing the ingredients to respective equipment to create a drink. Drink orders can be increasingly more complicated, in particular with increasing customization. The locations of the ingredients and equipment needed for one drink may be located at various locations that require the barista to travel. Storing the ingredients and equipment in a way that is practical and accessible for use and for refilling can also be challenging, especially at large scales.

### SUMMARY

The systems, methods and devices of this disclosure each have several innovative aspects, no single one of which is solely responsible for the desirable attributes disclosed herein.

A beverage station can include a first zone positioned below a countertop, a second zone positioned at a level of the countertop, and a third zone positioned at an overhead level. The third zone can include at least one reduced temperature zone.

In some configurations, the at least one reduced temperature zone can include at least one refrigerated dispense. The at least one refrigerated dispense can include an opening through a bottom surface of the least one refrigerated dispense. The opening can be configured to allow dispensing of an ingredient from underneath the at least one refrigerated dispense. The at least one refrigerated dispense can be mounted with an above counter support to a wall or a partition in the third zone. The above counter support can include at least two slides to allow movement of the at least one refrigerated dispense away or towards from the wall or the partition. The at least two slides can be attached to a bottom surface of the at least one refrigerated dispense. The beverage station can include a retractable drip tray configured to move between a first position positioned beneath the opening of the at least one refrigerated dispense and a second position away from the opening of the at least one refrigerated dispense. The retractable drip tray can be spring-loaded. The retractable drip tray can include a curved front surface. The retractable drip tray can be configured to move backwards or forwards when moving between the first position and the second position.

In some configurations, the first zone can further include a cup or lid dispense. The first zone can further include a cabinet for storing one or more gases. The beverage station can include one or more taps connected to the cabinet for storing one or more gases. The second zone can include the countertop and a sink. The second zone further can include a whip cream dispense positioned on the countertop. The second zone can further include at least one blender positioned on the countertop. The second zone can further include one or more ingredient dispenses, the one or more ingredient dispenses comprising one or more containers with pumps or scoops, wherein the one or more ingredient dispenses are positioned on the countertop. The second zone can further include one or more dry ingredient dispenses, the one or more dry ingredient dispenses comprising one or more containers to store dry ingredients, wherein the one or more dry ingredient dispenses are positioned on the countertop. The third zone can further include an ice dispense. The ice dispense can be an ice dispenser cabinet. The third zone can further include a cup or lid dispense. The cup or lid dispense can be a cup or lid dispenser cabinet. The third zone can further include one or more shelves. The third zone can further include a plurality of liquid dispenses. The plurality of liquid dispenses can include containers configured to dispense liquids. The plurality of liquid dispenses can be positioned on the one or more shelves. The plurality of liquid containers can be locked onto the one or more shelves. The reduced temperature zone can include a refrigerated zone or a freezer zone. The at least one reduced temperature zone can include an outlet for dispensing a beverage component. The outlet can be positioned above the countertop. The third zone can include a plurality of juice or tea dispenses, an ice dispense, a printer, a milk dispense, and an alternative milk dispense, and a sweet cream dispense. The second zone can include one or more dry ingredient dispenses, one or more blenders, one or more syrup dispenses, a sink, a whip cream dispense, and a nitro brew dispense. The third zone can include a plurality of juice or tea dispenses, an ice dispense, a printer, a milk dispense, and an alternative milk dispense. The second zone can include a plurality of dry ingredient dispenses, one or more blenders, one or more syrup dispenses, a sink, one or more sauce dispenses, a whip cream dispense, and a nitro brew dispense. The third zone can include a milk dispense, a plurality of alternative milk dispense, an ice dispense, and a printer. The second zone can include a plurality of dry ingredient dispenses, one or more blenders, one or more syrup dispenses, a sink, one or more sauce dispenses, a whip cream dispense, and a nitro brew dispense.

In yet another aspect, a method of forming a beverage comprising hot or cold ingredients can include dispensing at least one cold ingredient into a container from a location overhead. The at least one cold ingredient can be dispensed from a reduced temperature zone. The reduced temperature zone can include an ice dispense, a milk dispense, an alternative milk dispense, a tea dispense, or a juice dispense. The cold ingredients can be only added to the container from the location overhead.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1A schematically illustrates an embodiment of a beverage station.

FIG. 1B schematically illustrates another embodiment of a beverage station.

FIG. 2 illustrates another embodiment of a beverage station.

FIG. 3 illustrates an embodiment of a beverage station with equipment and ingredients.

FIG. 4 illustrates another embodiment of a beverage station with equipment and ingredients.

FIG. 5 illustrates yet another embodiment of a beverage station with equipment and ingredients.

FIG. 6A illustrates an above counter support system in a first position.

FIG. 6B illustrates the above counter support system of FIG. 6A in a second position.

FIG. 6C illustrates a close up of the above counter support system of FIG. 6B.

FIG. 7A illustrates an ice dispenser unit with a drip tray.

FIG. 7B illustrates a bottom perspective view of the drip tray of FIG. 7A.

FIG. 7C illustrates a top perspective view of the drip tray of FIG. 7B.

### DETAILED DESCRIPTION

Various extraction systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein.

Conventionally, in response to receiving a beverage order, a barista creates the beverage by retrieving or dispensing ingredients, such as pumping, scooping, or pouring ingredients from their respective containers which can be located at various places. The beverage order can also require different pieces of equipment, which can also be located at various places. Furthermore, customers often request modifications or customizations to the standard recipe. For example, a customer may want half the sugar and twice the amount of vanilla flavor, as compared to the standard recipe for a particular beverage. This can require precise control of dosing various ingredients. For example, a customer may want an additional ingredient, as compared to the standard recipe for a particular beverage. This can require a barista travelling to another area for this additional ingredient. Customization can place an additional burden on baristas, particularly as the operational approach and systems may be designed around specific, pre-determined beverage build recipes. Additionally, ingredient modifications often complicate beverage orders and further exacerbate the burden on baristas. For example, a customer ordering a customized beverage may ultimately receive a beverage with errors or there can be delays in preparing the beverage, which can negatively affect the customer's experience.

An aspect of the present disclosure, is the recognition that creating beverages can be time consuming and complex. Beverages can get increasingly complex and burdensome as recipes change, new recipes are added, and more customizations are possible. The process of building beverages can be labor intensive and can require a lot of space. Creating a beverage can include collecting and retrieving a variety of ingredients in various locations by hand. Additionally, creating a beverage can require moving a container to various stations to use different equipment. Various steps can take time and space, such as blending various ingredients.

Not only can these inefficiencies be time consuming, they can also cost more, especially in terms of labor costs. Additionally, baristas can often use excess amounts of ingredients to ensure the cup is full at the end of preparation, which can often lead to waste. As more ingredients and methods are offered, various ingredients or equipment can be positioned far away from each other, which can require baristas to travel distances between steps and increase production time.

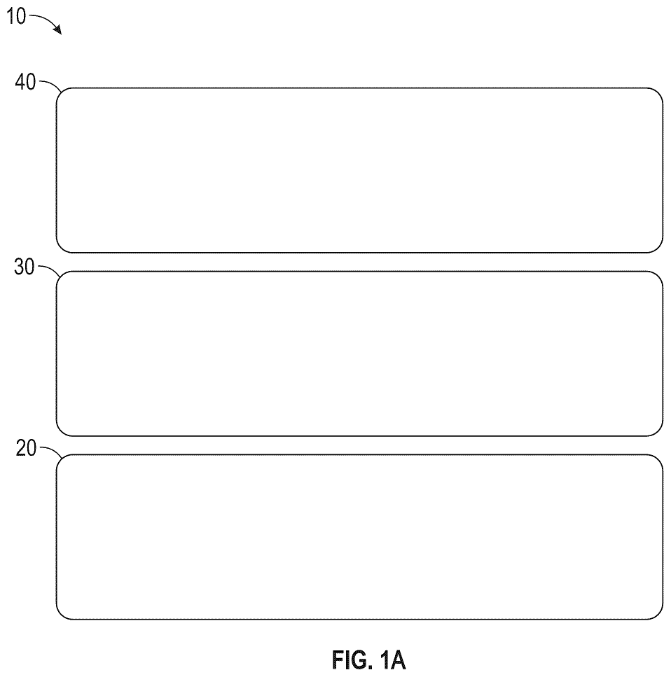

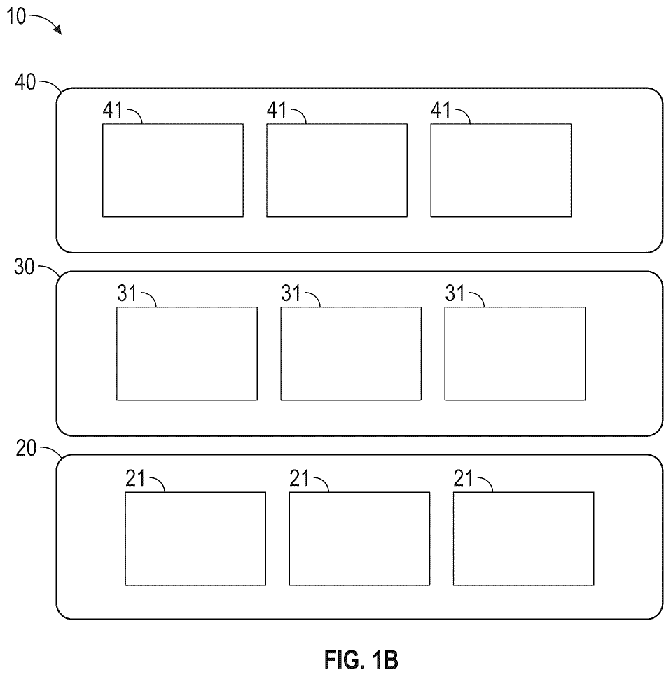

To address these or other concerns, disclosed herein is a system for preparing beverages in a beverage station. FIG. 1A schematically illustrates an embodiment of a beverage station 10. The system 10 can include various zones or levels. For example, the system 10 can include a first zone 20, a second zone 30 and a third zone 40. Each of these zones 20, 30, 40 can be positioned in a different vertical location or position to utilize the maximize the vertical space. For example, the first zone 20 can be a low zone, the second zone 30 can be a middle zone, and the third zone 40 can be an elevated or top zone. The use of zones in different vertical locations advantageously allows a user or barista to minimize travelling between various locations to access ingredients or equipment required to make a beverage. The use of zones can also advantageously allow the beverage station to be compact in taking smaller square footage. The beverage station can also be modular and flexible in that equipment and ingredients can be arranged in different configurations based on the needs and limitations of the space. The beverage station can also be built ergonomically to be designed for the user's comfort and efficiency in minimizing unnecessary motion.

FIG. 1B schematically illustrates another embodiment of a beverage station. As illustrated in FIG. 1B, the beverage station 10 can include a number of dispenses or dispensers in each of the zones 20, 30, 40. The dispenses can be configured to dispense one or more ingredients, components for a beverage, or beverages. For example, each of the zones 20, 30, 40 can include any one or more of: a sauce dispense, a syrup dispense, an espresso dispense, a steamed milk dispense, a milk dispense, a alternative dairy dispense, a hot water dispense, a tea dispense, a juice dispense, an ice dispense, a whip cream dispense, a coffee dispense, a nitro coffee dispense, or other dispenses for other ingredients. Each of the dispenses can be combined with one or more other dispenses. Each of the zones 20, 30, 40 can include additional components, such as storage or equipment, or a workspace. As will be described herein, each of the zones 20, 30, 40 can include dispenses that are maintained at reduced temperatures. Advantageously, the station can include reduced temperature zones for the one or more dispenses 41 in the third zone 40 positioned overhead. In one example, the third zone 30 can include a plurality of dispenses 41 including a milk dispense, an alternative milk dispense, and/or a cream dispense. Each of the plurality of dispenses 41 can be maintained at refrigerated or frozen temperatures.

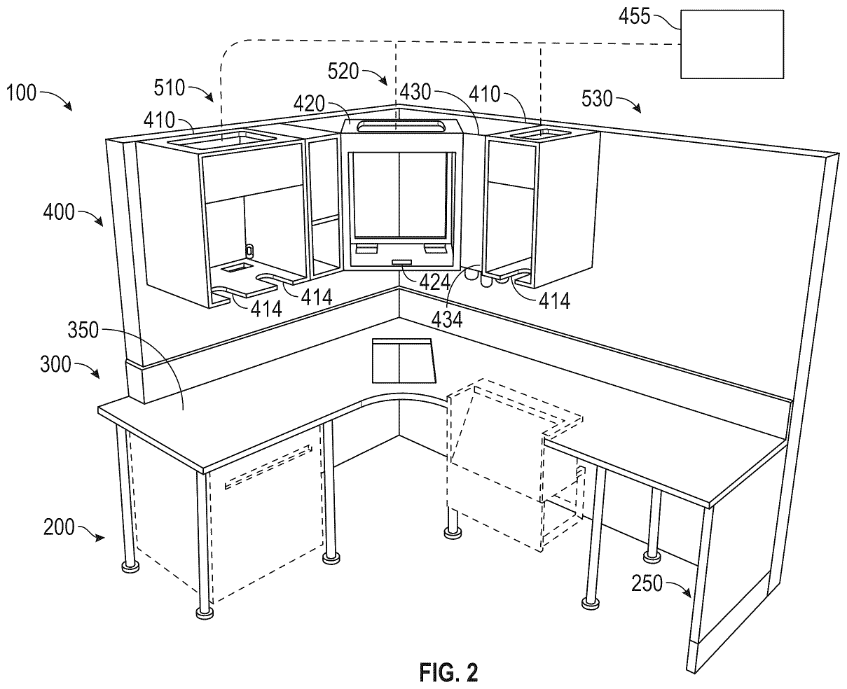

FIG. 2 illustrates an embodiment of a beverage station 100. The beverage station 100 can include a countertop or table 350. The beverage station 100 can also be positioned in a corner position which can allow the beverage station 100 to include two substantially perpendicular sides, which can increase the surface area available to the user. The beverage station 100 can include a first side 510 and a second side 530. In some examples, the first side 510 can be a left side of the beverage station 100 and the second side 530 can be a right side of the beverage station 100. In some examples, the beverage station can also have a middle area 520 positioned between the first side 510 and the second side 530. In other examples, the beverage station 100 can be positioned along a single linear wall. The beverage station 100 can include a first zone 200 at a level below the countertop 350, a second zone 300 at the level of the countertop 350, and a third zone 400 at a level above the countertop 350 or an overhead level. The first zone 200 can include a variety of spaces 250 between the floor and the countertop 350. These floor spaces 250 can advantageously be used to store larger and heavier equipment, such as refrigerators. The countertop 350 can also include openings or slots at the to accommodate equipment and to allow access for dispensing from above without having to reach under or around the countertop 350. The second zone 300 can include a variety of spaces on the countertop 350. This space on the countertop 350 can be used to store equipment that is frequently used and accessed. The third zone 400 can include one or more cabinets 450 and/or shelving. The one or more cabinets 450 or shelves can be mounted to a wall at a raised or elevated level. In some examples, one or more of the cabinets 450 can be refrigerated or temperature controlled. The cabinets 450 can include openings or slots at the lower or bottom surface to advantageously allow dispensing from underneath the cabinets 450. This can allow a user to access the equipment or ingredients more easily from below the cabinets 450. This can also allow ingredients to be dispensed without requiring a user to lift a container or scoop an ingredient. In other examples, the cabinets 450 can include one or more refrigerated or temperature controlled cabinets without dispensing features. For example, a temperature controlled cabinet can be a reduced temperature cabinet that is configured to receive an ingredient dispense. In some examples, the ingredient dispense can be a milk dispense which can be used to dispense milk. A user can open the temperature controlled cabinet to access the ingredient dispense. The user can pull the dispense milk completely or partially out of the temperature controlled cabinet to then dispense the ingredient from the ingredient dispense. In one example, the milk dispense can be pulled forward such that a nozzle can be accessed to dispense an ingredient directly into a container.

The countertop 350 can be characterized by a height as measured from the floor. In some examples, the height of the countertops 350 from the floor can range from 27 inches to 41 inches and in certain embodiments between 30 inches to 38 inches or between 32 inches to 36 inches. In some examples, the cabinets 450 can be characterized by a height as measured between the surface of the countertop 350 and a lower surface of the cabinet 450 through which the openings or slots are present to accommodate one or more dispensers to extend through. This height of the cabinets 450 from the countertop 350 can range from 19 inches to 29 inches and in certain embodiments between 21 inches to 26 inches or between 22 inches to 25 inches. In some examples, the cabinets 450 can also be characterized by a height as measured from the lower surface of the cabinets 450 to an upper surface of the cabinets 450. This height of the cabinets 450 between the upper and lower surfaces can range between 22 inches to 33 inches, and in certain embodiments between 25 inches and 31 inches or between 26 inches and 30 inches. The shelves can be characterized by a height as measured between the surface of the countertop 350 and a lower surface of the shelves. In some examples, the height of the shelves from the countertop 350 can range from 8 inches to 14 inches and in certain embodiments between 9 inches to 12 inches, and in certain embodiments between 10.5 inches to 11.5 inches. In some examples, the height of the shelves from the countertop 350 can range from 19 inches to 29 inches and in certain embodiments between 21 inches to 26 inches or between 22 inches to 25 inches. The countertop 350 can be characterized by a square footage as measured on the surface of the countertop 350. In some examples, the square footage of the countertops 350 can range from 20 ft² to 30 ft² and in certain embodiments between 18 ft² to 22 ft² or between 19 ft² to 21 ft².

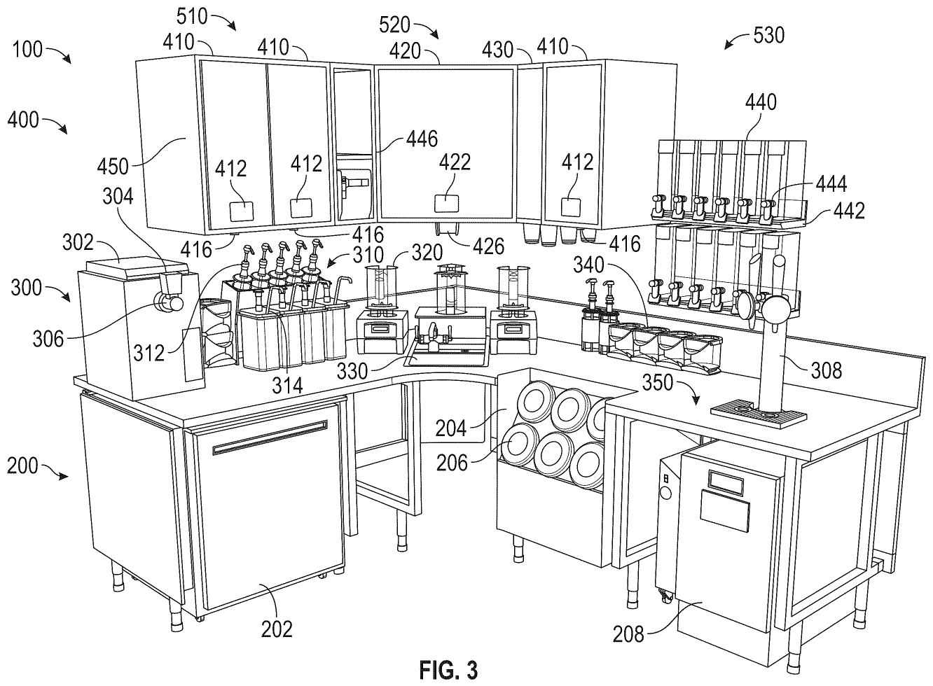

FIG. 3 illustrates an embodiment of a beverage station 100 with equipment and ingredients positioned in the various zones. As previously described, the beverage station 100 can include a first zone 200 below the countertop 350, a second zone 300 at the level of the countertop 350, and a third zone 400 above the countertop 350 or overhead.

The first zone 200 can include a variety of spaces 250 between the floor and the countertop 350. As illustrated in FIG. 3, the first zone 200 can include a refrigerator 202 to store ingredients that need to be temperature controlled. The first zone 200 can also include a cup and/or lid dispenser 204. The cup and/or lid dispenser 204 can include a series of cavities 206 that can be filled with various cups and lids of different sizes. The cup and/or lid dispenser 204 can be angled to allow a user to easily retrieve cups and/or lids. The countertop 350 can include a cutout around the cup and/or lid dispenser 204, which can allow a user to reach down to retrieve a cup or a lid without having to reach around or underneath the countertop 350. The first zone 200 can also include a nitro system which can include a storage cabinet or unit 208 for the nitrogen gas. In other embodiments, the storage cabinet or unit 208 can alternatively or additionally store other gases or ingredients, such as for carbonation or other gases.

The second zone 300 can include a variety of spaces on the countertop 350. The second zone 300 can have one or more dispenses that can dispense various ingredients, beverages, or components. For example, the second zone 300 can include a sauce and syrup dispense, an espresso and steamed milk dispense, a milk and an alternative milk dispense. In other examples, the second zone 300 can include a cup dispense, a lid dispense, or an order dispense. The dispenses can come in various forms. The dispenses can be configured to allow the ingredient or beverage contained therein to be dispensed directly from the dispense, such as into a cup. For example, the dispenses can be a container with a nozzle, a container with a pump, a container with a scoop, a container with a lid, and various other configurations. The dispenses can be configured to allow the component contained therein to be dispensed directly from the dispense, such as into a user's hand. The second zone 300 can include a whipped cream dispense or dispenser 302. The whip cream dispenser 302 can include a nozzle 306 with a handle 304. The second zone 300 can also include a plurality of containers 310 with pumps 312 to dispense syrups and other liquid ingredients. The second zone 300 can also include a plurality of containers with scoops 314 for ingredients such as powders or toppings. The second zone 300 can also include a plurality of containers 340 that can be used to store dry ingredients. The second zone 300 can also include one or more blenders 320 that can be used to blend ingredients. The second zone 300 can also include a sink 330. The sink 330 can include at least a drain. In some examples, the sink 330 can also include a water supply connected to a water source. The second zone 300 can also include one or more taps 308 (such as for a nitro system), which can be connected to the unit 208 for storing one or more gases (such as nitrogen). The one or more taps 308 can include a device by which a flow of liquid or gas from a pressurized vessel can be dispensed. The one or more taps 308 can be used to infuse a beverage with one or more gases (such as nitrogen, carbonation, or other gases). The countertop 350 can include a cutout such as an opening or a slot to allow connection between the one or more taps 308 and the unit 208 for storing one or more gases. In one example, the second zone can include one or more dry one or more dry ingredient dispenses 340, one or more blenders 320, one or more syrup dispenses 312, a sink 330, a whip cream dispense 302, and a nitro brew dispense 308. The first zone 200 or the third zone 400 can also include dispenses as described herein.

The third zone 400 can include at least one reduced temperature zone. The reduced temperature zone can include one or more ingredient dispenses 450. Each of the one or more ingredient dispenses 450 can contain the ingredient directly therein or hold a container for the ingredient, such as a bag or container of the ingredient. Each of the one or more ingredient dispenses 450 can dispense the ingredient directly from the ingredient dispense into a container or a cup. The reduced temperature zone can include an ingredient dispense 450 in the form of a cabinet that is maintained at a reduced temperature. In some examples, one or more of the cabinets 450 can be temperature controlled. For example, the one or more cabinets 450 can be maintained in refrigerated or frozen temperatures. Each reduced temperature zone can include an ingredient dispense with an outlet 416, 426 for dispensing a beverage component. The outlet can be positioned above the countertop. The third zone 400 can include a variety of cabinets 450 and/or shelving that can be mounted to a wall at a raised or elevated position. The cabinets 450 can include an ice dispenser cabinet 420. The ice dispenser cabinet can be considered an ice dispense. The ice dispense 420 can be a cabinet or a container that directly receives the ice therein and is configured to automatically dispense ice from the cabinet or container. In other examples, the ice dispenser cabinet 420 can hold an ice dispenser that can be configured to automatically dispense ice. In some examples, the ice dispenser cabinet can also be an ice maker or connected to an ice maker. The ice dispenser cabinet 420 can have an opening or slot on a lower or bottom surface to accommodate a dispensing outlet or funnel 426 to allow ice to be dispensed from underneath the cabinet 420. This can allow a user to access ice more easily from below the cabinet 420. This can also advantageously use gravity to aid in dispensing ice from the cabinet 420. The ice dispenser cabinet 420 can also include a user interface 422 with controls (such as buttons) to allow a user to select an amount of ice to dispense. The ice dispenser cabinet 420 can be configured to precisely dose and dispense predetermined amounts. In certain embodiments, the temperature of the cabinets 420 can be maintained at freezer temperatures between 0° F. and 32° F. and in certain embodiments below 32° F.

The one or more ingredient dispenses 450 can include one or more liquid dispenser cabinets 410. The one or more liquid dispenser cabinets 410 can be considered a liquid dispense or a dispense for the liquid ingredient or beverage contained therein. Many of the embodiments described herein involve dispensing liquid, such as milk or a non-dairy liquid. For instance, in some embodiments, the liquid may be milk, cream, almond milk, soy milk, oat milk, coconut milk, cashew milk, other alternative milks, other plant-based liquids, coffee, tea, or hemp extract. The liquid dispenser cabinets 410 can be refrigerated to keep temperatures of the dairy ingredients at safe temperatures. To dispense edible liquids safe for human consumption, the liquid can be stored at safe temperatures to prevent the growth of pathogens and prevent spoilage. In certain embodiments, the temperature of the cabinets 450 may be maintained at refrigerated temperatures between 30° F. and 45° F. and in certain embodiments between 33° F. and 42° F. and in certain embodiments between 30° F. and 41° F. In certain embodiments, the temperature can be maintained not exceeding 41° F. In some examples, the temperature can be maintained at around 0° F. In some examples, the temperature can be maintained not exceeding 0° F. In this manner, the liquid dispense can be considered a refrigerated, frozen, or reduced temperature liquid dispense. The one or more dispense cabinets 450 can be associated with a cooling system 455 for maintaining the cabinet 450 at reduced temperatures. In other examples, the dispense cabinets 450 can be unrefrigerated and maintain liquids at room temperature. The dispense cabinet 450 can be a liquid dispense 410. The dispense cabinet 450 can include a liquid dispense or dispenser which can have a container for storing a liquid. In some embodiments, valves or other equipment can be used to control dispensing of the ingredients through portions of the dispense cabinet, such as cutouts or outlets of the dispense cabinet. The liquid dispenser cabinets 410 can be configured to accommodate liquid containers, such as jugs, containers, or bags of liquid. The liquid dispenser cabinets 410 can be configured to directly receive and contain liquids therein. The liquid dispenser cabinets 410 and/or the liquid containers can have a mechanism that allows the liquid to be dispensed upside down, such as through an opening or slot in a lower or bottom surface of the cabinet 410. The liquid dispenser cabinets 410 can have an opening or slot 414 on a lower or bottom surface to accommodate a dispensing outlet or funnel 416 to allow liquid to be dispensed from underneath the cabinets 410. The dispensing outlet or funnel 416 can be connected to the containers or bags of liquid or with the interior of the liquid contained therein. Each liquid dispenser cabinet 410 can include an outlet 416 for dispensing a beverage component, such as a liquid beverage or ingredient. The outlet 416 can be positioned above the countertop. This can allow a user to access liquid more easily from below the cabinets 410. This can also advantageously use gravity to aid in dispensing liquid from the cabinets 410. The liquid dispenser cabinets 410 can also include a user interface 412 with controls (such as buttons) to allow a user to select an amount of liquid to dispense. The liquid dispenser cabinets 410 can be configured to precisely dose and dispense predetermined amounts. In one example, the first dispense 410 can be a milk dispense, the second dispense 410 can be an alternative milk dispense, an ice dispense 420, a third dispense 410 can be a sweet cream dispense.

The cabinets 450 can also include one or more cup and/or lid dispenser cabinets 430. The cup and/or lid dispenser cabinets 430 can be considered a cup and/or lid dispense. The cup and/or lid dispenser cabinets 430 can include a plurality of openings or slots 434 to accommodate various cups and lids of different sizes. The plurality of openings or slots 434 can be positioned through a lower or bottom surface of the cup and/or lid dispenser cabinets. This can allow a user to access cups or lids more easily from below the cabinets 450.

The third zone 400 can also include one or more shelves 442 that can mount one or more liquid containers 440 to a wall. The liquid containers 440 can be considered a liquid dispense or a dispense for the liquid ingredient or beverage contained therein. The liquid containers 440 can be positioned on or locked onto the one or more shelves 442. The liquid containers 440 can be configured to contain liquid beverages or ingredients such as tea, juice, water, or other liquids. The liquid containers 440 can include a nozzle or handle 444 that can allow a user to dispense the liquid into a cup or container without having to lift or pour a container. This can minimize strain on the user and avoid spillage. Furthermore, the nozzle or handle 444 can also allow a user to use a single hand to dispense the liquid directly into a cup or container. In other examples, other containers for ingredients or equipment can be positioned or locked onto the shelves 442. The shelves 442 and cabinets 450 can be mounted to a wall or a partition of the beverage station 100. The third zone 400 can also include a printer 446 that can print orders or receipts.

As previously described, the beverage station 100 can also be positioned in a corner position which can allow the beverage station 100 to include two substantially perpendicular sides, which can increase the surface area available to the user. The beverage station 100 can include a first side 510 and a second side 530. In some examples, the first side 510 can be a left side of the beverage station 100 and the second side 530 can be a right side of the beverage station 100. In some examples, the beverage station can also have a middle area 520 positioned between the first side 510 and the second side 530. Within the first zone 200, the refrigerator 202 can be positioned on the first or left side 510. Within the first zone 200, the cup or lid dispenser 204 and the storage cabinet or unit 208 for one or more gases can be positioned on the second or right side 530. Within the second zone 300, the whip cream dispenser 302, the plurality of containers with pumps 312, the plurality of containers with scoops 314 can be positioned on the first or left side 510. Within the second zone 300, the plurality of containers for dry ingredients 340 and the one or more taps 308 can be positioned on the second or right side 530. Within the second zone 300, the plurality of containers with pumps 312 can be positioned on the second or right side 530. Within the second zone 300, the sink 330 and the one or more blenders 320 can be positioned in a middle area between the first side 510 and the second side 530. Within the third zone 400, at least one of the liquid dispense cabinets 410 can be positioned on the first or left side 510. Within the third zone 400, at least one of the liquid dispense cabinets 410 and the cup or lid dispenser cabinet 430 can be positioned on the second or right side 530. Within the third zone 400, the ice dispenser cabinet 420 can be positioned in the middle area 520 between the first side 510 and the second side 530.

The beverage station 100 can be modular in that the components placed in each of the zones (such as the first, second, or third zones) and/or sides (first side, middle area, or second side) can be rearranged within the zones/sides or positioned in different zones/sides. For example, the whip cream dispenser 302 can be positioned in one of the cabinets 450 in the third zone 300. In another example, the containers for dry ingredients 340, pump containers 312 for liquid ingredients, a plurality of containers with scoops 314 can be positioned within a cabinet 450 or mounted to a shelf 442 in the third zone 300. In another example, the ice dispenser can be positioned under the countertop 350 in the first zone 200. In another example, the whip cream dispenser 302 can be positioned on the second side 530. In another example, the ice dispenser cabinet can be positioned on the first or second sides 510, 530. The equipment and ingredients can be rearranged based on user preference or based on the limitations or requirements of the space.

The beverage station 100 can additionally or alternatively include other types of equipment, such as an espresso maker, a coffee maker, a cold brewer, an iced tea maker, a heater, a shaker, a blender, a whip cream dispenser, a steam wand, a steamer, or a frother. The beverage station 100 can additionally or alternatively include other types of ingredients, such as toppings, powders, syrup, drizzle, sauces, or other flavorings. As discussed above, each of these components can be positioned in any of the zones 200, 300, 400.

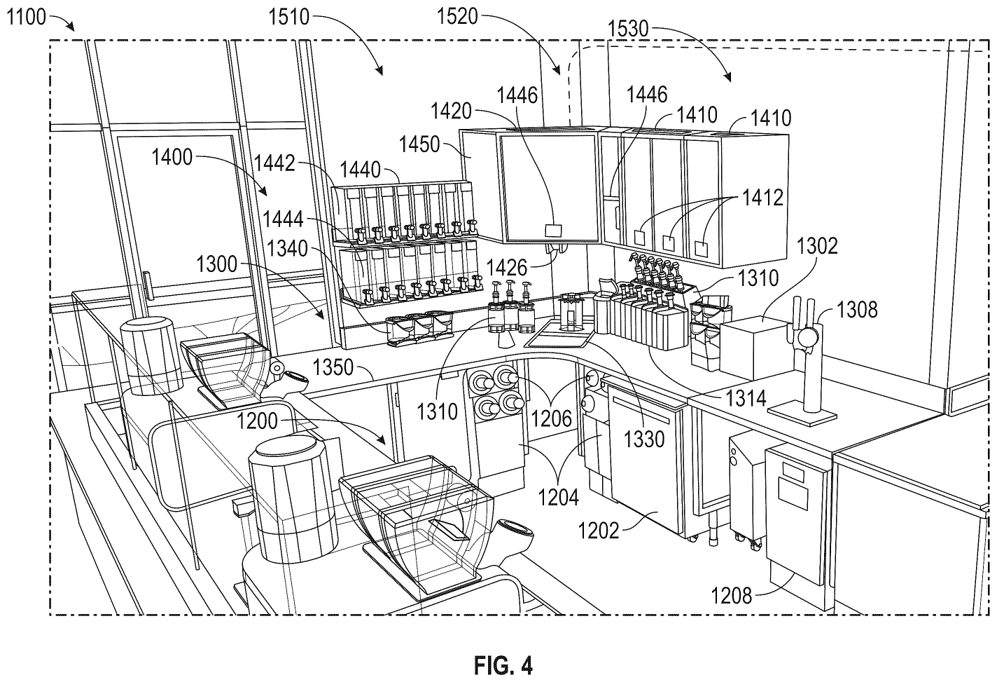

In FIGS. 4-7C, like numbers are used to refer to parts similar to those of FIG. 3 and reference can be made to the description of those parts with reference to the description of the other figures. FIG. 4 illustrates another embodiment of a beverage station with equipment and ingredients positioned in various zones. As with the embodiment described with reference to FIG. 3, the beverage station 1100 can include a first zone 1200 below a surface or countertop 1350, a second zone 1300 at the level of the countertop 1350, and a third zone 1400 above the countertop 1350 or overhead.

Similar to the beverage station 100 in FIG. 3, the beverage station 1100 as illustrated in FIG. 4 can also be positioned in a corner position which can allow the beverage station 1100 to include two substantially perpendicular sides, which can increase the surface area available to the user. The beverage station 1100 can include a first side 1510 and a second side 1530. In some examples, the first side 1510 can be a left side of the beverage station 100 and the second side 1530 can be a right side of the beverage station 100. In some examples, the beverage station can also have a middle area 1520 positioned between the first side 1510 and the second side 1530.

The first zone 1200 can include a variety of spaces beneath the countertop 1350. As illustrated in FIG. 4, the first zone 1200 can include a refrigerator 1202. The first zone 1200 can also include a cup and/or lid dispenser 1204. As shown in FIG. 4, the first zone 1200 can include two cup and/or lid dispensers 1204. A first cup and/or lid dispenser 1204 can be positioned on the first side 1510 and a second cup and/or lid dispenser 1204 can be positioned on the second side 1530. Both the cup and/or lid dispensers 1204 can be positioned adjacent to the middle portion 1520 of the beverage station 1100. This can advantageously allow a user to easily access the cups and lids while positioned at or near the middle portion 1520. The first zone 1200 can also include a nitro system which can include a storage cabinet or unit 1208 for the nitrogen gas. Within the first zone 1200, the refrigerator 1202 can be positioned on the second or right side 1530. Within the first zone 1200, the storage cabinet or unit 1208 for one or more gases can be positioned on the second or right side 1530.

The second zone 1300 can include a variety of spaces on the countertop 1350. The second zone 1300 can include a whipped cream dispenser 1302. The second zone 1300 can also include a plurality of containers 1310 with pumps 1312 to dispense syrups, sauces, and other liquid ingredients. The second zone 1300 can also include a plurality of containers with scoops 314 for ingredients such as powders or toppings. The plurality of containers with scoops 314 can also contain liquid ingredients, such as sauces. The second zone 1300 can also include a plurality of containers 1340 that can be used to store dry ingredients. The second zone 1300 can also include one or more blenders 1320 that can be used to blend ingredients. The second zone 1300 can also include a sink 1330. The second zone 1300 can also include one or more taps 1308 (such as for a nitro system), which can be connected to the unit for storing one or more gases (such as nitrogen) 1208 positioned in the first zone 1200. The one or more taps 1308 can include a device by which a flow of liquid or gas from a pressurized vessel can be dispensed. The unit for storing one or more gases 1208 can be used to infuse a beverage with one or more gases (such as nitrogen, carbonation, or other gases). The infused beverage (such as nitro cold brew) can be dispensed from the one or more taps 1308. The countertop 1350 can include a cutout such as an opening or a slot to allow connection between the one or more taps 1308 and the unit 1208 for storing one or more gases.

Within the second zone 1300, the whip cream dispenser 1302, the plurality of containers with pumps 1312, the plurality of containers with scoops 1314 can be positioned on the second or right side 1530. Within the second zone 1300, the plurality of containers for dry ingredients 1340 can be positioned on the first or left side 1510. The one or more taps 308 can be positioned on the second or right side 1530. Within the second zone 1300, the plurality of containers with pumps 1312 can be positioned on the second or right side 1530. Within the second zone 1300, the sink 1330 and the one or more blenders 1320 can be positioned in a middle area 1520 between the first side 1510 and the second side 1530.

The third zone 1400 can include at least one reduced temperature zone. The reduced temperature zone can include a cabinet or unit or ingredient dispense 1450 that is maintained at a reduced temperature. In some examples, the one or more of the ingredient dispenses 1450 can be temperature controlled. The ingredient dispenses 1450 can include an ice dispense 1420. The ice dispense 1420 can have an opening or slot on a lower or bottom surface to accommodate a dispensing outlet or funnel 1426 to allow ice to be dispensed from underneath the ice dispense 1420. In certain embodiments, the temperature of the ice dispense 1420 can be maintained at freezer temperatures between 0° F. and 32° F. and in certain embodiments below 32° F.

The one or more units or ingredient dispenses 1450 can include one or more liquid dispenses 1410. The one or more liquid dispenser cabinets 1410 can be considered a liquid dispense or a dispense for the liquid ingredient or beverage contained therein. The liquid dispenser cabinets 1410 can have an opening or slot 1414 on a lower or bottom surface to accommodate a dispensing outlet or funnel (not shown) to allow liquid to be dispensed from underneath the cabinets 1410. Each liquid dispenser cabinet 1410 can include an outlet for dispensing a beverage component, such as a liquid beverage or ingredient. The outlet can be positioned above the countertop 1350. This can allow a user to access liquid more easily from below the cabinets 1410. This can also advantageously use gravity to aid in dispensing liquid from the cabinets 1410. The liquid dispenser cabinets 1410 can also include a user interface 1412 with controls (such as buttons) to allow a user to select an amount of liquid to dispense. The liquid dispenser cabinets 1410 can be configured to precisely dose and dispense predetermined amounts. In one example, the third zone 1400 can include an ice dispense 1420, the first ingredient dispense 410 can be a milk dispense, the second ingredient dispense 410 can be an alternative milk dispense, and a third dispense 410 can be a sweet cream dispense.

The third zone 1400 can also include one or more shelves 1442 that can mount one or more liquid dispenses 1440 to a wall or panel positioned above the countertop 1350. The liquid dispenses 1440 can be liquids containers. The liquid dispenses 1440 can be positioned on or locked onto the one or more shelves 1442. The liquid dispenses 1440 can be configured to contain liquid beverages or ingredients such as tea, juice, water, or other liquids. The liquid dispenses 1440 can each include a nozzle or handle 1444 that can allow a user to dispense the liquid into a cup or container without having to lift or pour a container 1440. This can minimize strain on the user and avoid spillage. Furthermore, the nozzle or handle 1444 can also allow a user to use a single hand to dispense the liquid directly into a cup or container. In other examples, other containers for ingredients or equipment can be positioned or locked onto the shelves 1442. The shelves 1442 and cabinets 1450 can be mounted to a wall or a partition of the beverage station 1100. The third zone 1400 can also include a printer 1446 that can print orders or receipts.

Within the third zone 1400, at least one of the liquid dispenses 1410 can be can be positioned on the second or right side 1530. The liquid dispenses 1410 can be liquid dispense cabinets. Within the third zone 400, the ice dispense 1420 can be positioned in the middle area 1520 between the first side 1510 and the second side 1530. The ice dispense 1420 can be an ice dispense cabinet.

The beverage station 1100 can be modular in that the components placed in each of the zones (such as the first, second, or third zones) and/or sides (first side, middle area, or second side) can be rearranged within the zones/sides or positioned in different zones/sides. The equipment and ingredients can be rearranged based on user preference or based on the limitations or requirements of the space.

The beverage station 1100 can additionally or alternatively include other types of equipment, such as an espresso maker, a coffee maker, a cold brewer, an iced tea maker, a heater, a shaker, a blender, a whip cream dispenser, a steam wand, a steamer, or a frother. The beverage station 1100 can additionally or alternatively include other types of ingredients, such as toppings, powders, syrup, drizzle, sauces, or other flavorings. The beverage station can include duplicate equipment in different or the same areas. As discussed above, each of these components can be positioned in any of the zones 200, 300, 400.

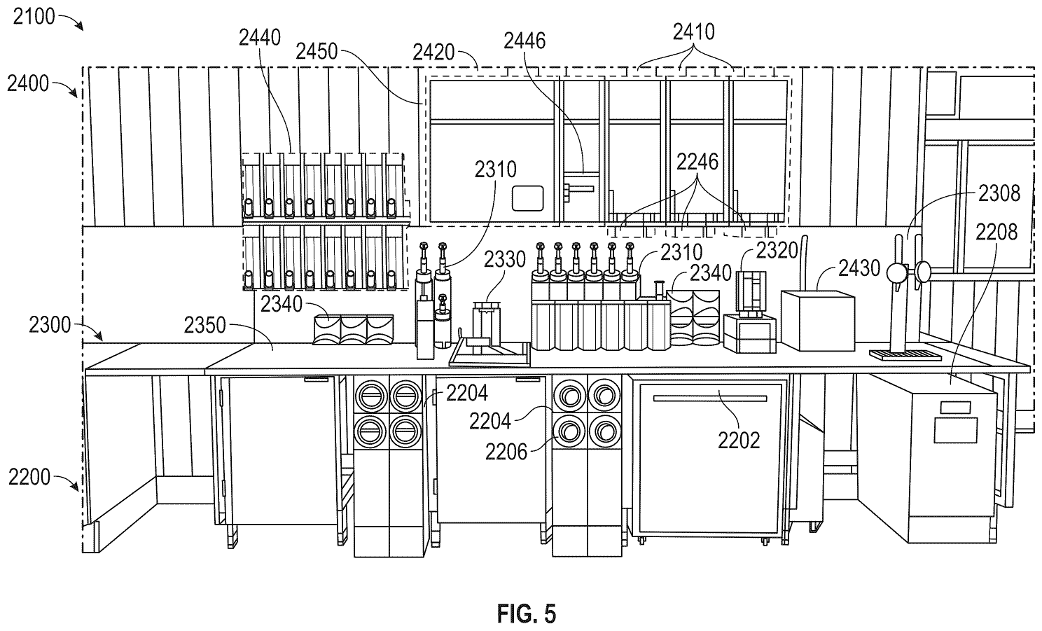

FIG. 5 illustrates another embodiment of a beverage station with equipment and ingredients positioned in various zones. As with the embodiment described with reference to FIGS. 3 and 4, the beverage station 2100 can include a first zone 2200 below a surface or countertop 2350, a second zone 2300 at the level of the countertop 2350, and a third zone 2400 above the countertop 2350 or overhead.

As shown in FIG. 5, the beverage station 2100 can be linear or positioned on one side, against one wall. Instead of having two sides perpendicular to one another as in FIGS. 3 and 4, the beverage station 2100 in FIG. 5 can include a single side or two sides that are parallel to one another. The first zone 2200 can include a refrigerator 2202, one or more cup and/or lid dispenses or dispensers 2204, and a unit for storing one or more gases 2208. The second zone 2300 can include dry dispenses 1340, such as plurality of containers that can be used to store dry ingredients. The second zone 2300 can also include a liquid dispenses 2310, such as plurality of containers with pumps that can be used to dispense liquids, such as syrups and sauces. The second zone 2300 can also include a sink 2330, one or more blenders 2320, and a whip cream dispense or dispenser 2430. The second zone 2300 can also include one or more taps 2308 to dispense infused liquids. The one or more taps 2308 can be connected to the unit for storing one or more gases 2208. The third zone 2400 can include at least one reduced temperature zone. The third zone 2400 can include one or more liquid dispenses 2440, which can be containers that can be positioned on or locked onto shelves mounted to the wall. The third zone 2400 can also include units 2450. These units 2450 can include ingredient dispenses 2410. The ingredient dispenses 2410 can include a series of cabinets or storage units. One or more of the units 2450 can be refrigerated or equipped to maintain reduced temperatures. The third zone 2400 can include an ice dispense or dispenser 2420, such as an ice dispenser cabinet. The ice dispense 2420 can be an ice maker or be connected to an ice maker. The third zone 2400 can also include one or more liquid dispenser cabinets 2410. The third zone 2400 can also include a printer 2446 that can print orders or receipts.

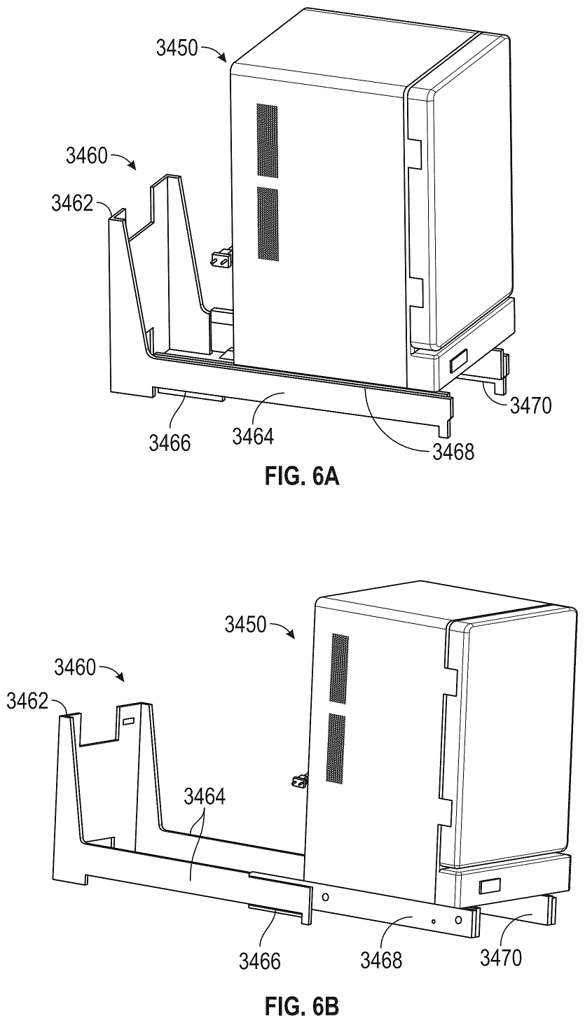

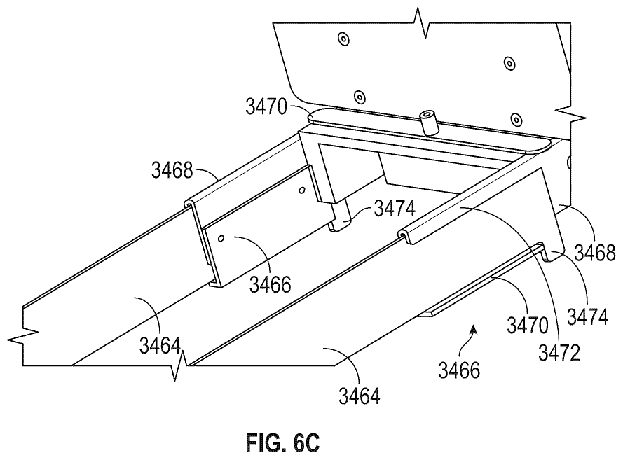

FIG. 6A illustrates an above counter support system in a first position. FIG. 6B illustrates the above counter support system of FIG. 6A in a second position. FIG. 6C illustrates a close up of the above counter support system of FIG. 6B. As shown in FIGS. 6A and 6B, the above counter support 3460 can support or hold a unit 3450. The unit 3450 can be a cabinet. In some configurations, the unit 3450 can be a liquid dispense or dispenser, a cup and/or lid dispense or dispenser, an ice dispense or dispenser, or other types of dispensers. Each of the dispenses can be a cabinet. The above counter support 3460 can be mounted or attached to a wall or partition (not shown). An above counter support 3460 can be used on any one or more of the units, such as cabinets, in the beverage stations as described herein. In particular, an above counter support 3460 can be used to mount one or more units, such as cabinets, in the third zone positioned overhead or above a countertop in the beverage station.

The above counter support system 3640 can mount an unit 3450 and allow the cabinet 3450 to slide forward and backward in a horizontal plane. The above counter support system 3640 can allow a user to move the unit 3450 towards or away from a wall or partition. The above counter support 3460 can allow for a user to move the unit 3450 in a forward or backward direction with minimal effort required from the user.

The above counter support 3640 can include a captive slide. The above counter support 3640 can include two rails 3464 that are substantially parallel to one another. In some embodiments, more than two rails can be used. The above counter support system 3640 can further include a front and back stops to prevent the unit 3450 from sliding off the back or front of the rails 3464. The above counter support system 3640 can include a back plate or wall mounting bracket 3462 connected to or integral with the ends of each of the rails 3464. The back plate 3462 can be attached to a wall or partition to mount the above counter support system 3640. The above counter support 3640 can also include a slide 3468 to each of the rails 3464. In some embodiments, more than two slides can be used. Each of the slides 3468 can be connected or attached to an interior surface of each of the rails 3464. Each slide 3468 can attach to the respective plate 3466 with a nut. The slide 3468 and the plate 3466 can together form a structure that is configured to receive and secure a rail 3464. As shown in FIG. 6C, the slide 3468 can have a rim or lip 3472 which extends outward from the upper surface of the slide 3468. The rim or lip 3472 can receive a top surface of the rail 3464. The rim or lip 3472 can be curved to further secure the rail 3464 and prevent the rail 3464 from separating from the slide 3468, such as in a lateral or vertical direction. Similarly, the plate 3466 attached to the slide 3468 can include a rim or lip 3470 that extends outward and is configured to receive a bottom surface of the rail 3464. The rim 3470 can further curve to further secure the rail 3464 and prevent the rail 3464 from separating from the slide 3468, such as in a lateral or vertical direction. The use of these components of the above counter support system 3640 are advantageously easily cleanable and easily disassembled, such that the parts are simple and come apart easily without the use of additional tools.

With the above described configuration, the slide 3468 can remain securely attached to the rail 3464 and also be configured to slide or move horizontally relative to the rail 3464. In other words, the slide 3468 can move along the length of the rail 3464 that it is connected to.

The front end of the rail 3464 can include a front stop in the form of an extension or protrusion 3474. The extension or protrusion 3474 can extend in a downward direction. In this manner, the protrusion 3474 can act as a stop in preventing the plate 3466 from sliding off the front of the rail 3464. Since the plate 3466 is attached to the slide 3468, the slide 3468 is also stopped from sliding off the rail 3464. In this manner, the front stop 3474 can prevent the cabinet 3450 from sliding off the front of the rail 3464. Similarly, the back end of the rail 3464 on the opposing end can include a back stop in the form of an extension or protrusion. The back plate 3462 can also or alternatively act as a back stop to prevent the cabinet 3450 from sliding off the back end of the rail 3464.

The slide 3468 can attach to or secure to a bottom surface of the cabinet 3450. The two slides 3468 can be attached to opposing ends of the bottom surface of the cabinet 3450, such as lateral edges of the bottom surface of the cabinet 3450. This can advantageously leave a majority of the bottom surface of the cabinet 3450 exposed and easily accessible for cleaning. In other embodiments, the slide 3468 can attach to the lateral sides or an upper surface of the cabinet 3450. In this manner with the slides 3468 connected, the cabinet 3450 can be slid or moved forward and backward as the attached slides 3468 are moved forward and backward relative to the rails 3468. The cabinet 3450 can thus be moved towards and away from the wall or partition the cabinet 3450 is mounted to. This advantageously allows the bottom surface of the cabinet 3450 to be easily cleaned when the cabinet 3450 is slid forward. In particular, the cabinet 3450 can be slid forward to clean the bottom and sides of the cabinet 3450 that would otherwise be obstructed or difficult to access. This advantageously allows the cabinets 3450 to be positioned closer together because it would not be required to keep separation between the cabinets 3450 to allow for cleaning. The cabinet 3450 sliding forward away from the wall and backwards towards the wall can also advantageously improve operating ergonomics in addition to cleaning ergonomics. The cabinet 3450 can be slid forward and backward for refilling and emptying the ingredient contained therein. For example, the cabinet 3450 can be pulled forward to remove an empty bag of liquid from the cabinet and replaced with a full bag of liquid. The sliding operation can also be used for maintaining, servicing, or repairing the cabinet 3450. The use of slides 3468 can allow the cabinet 3450 to be moved along a plane bearing surface. The resistance of the slides 3468 can be used to keep the cabinet 3450 in place during operation, such as during cleaning, dispensing, restocking, or during maintenance. The use of slides 3468 can advantageously use frictional force can keep the cabinet 3450 in place during various modes of operation. In this manner, the cabinet 3450 can be maintained in position without interfering with the activity of the user on the cabinet 3450. In other embodiments, the system can include a retaining force, such as a lock or a detent, to keep the cabinet 3450 in place during various modes of operation. In some examples, the use of slides 3468 can advantageously eliminate the need for rollers. In some embodiments, the use of rollers can be used instead of or in addition to slides.

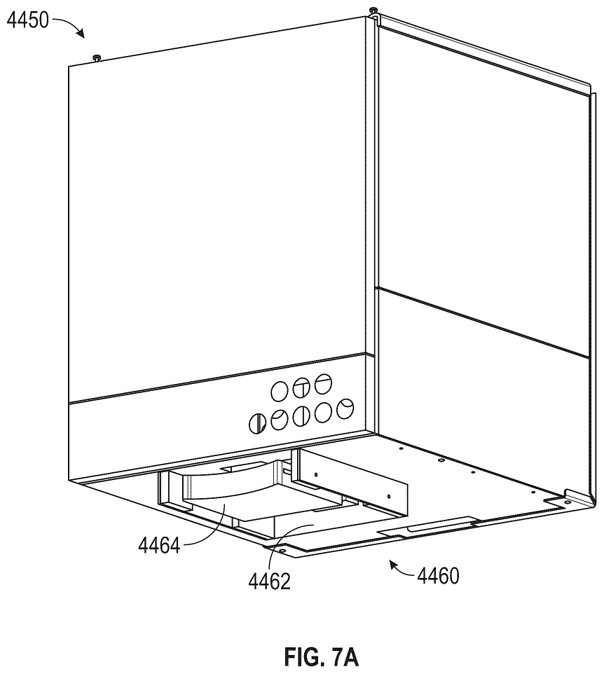

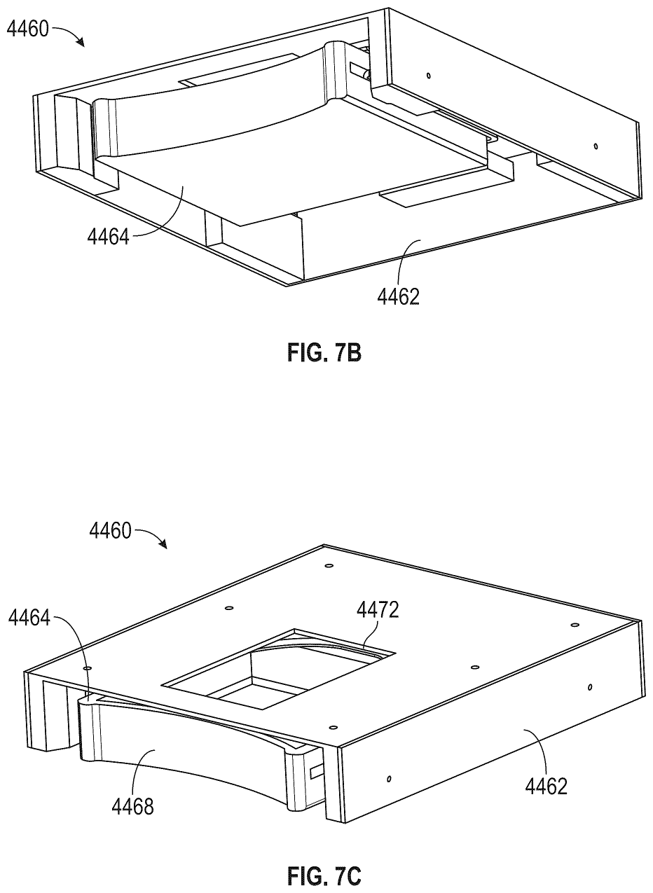

FIG. 7A illustrates an ice dispenser unit with a drip tray. FIG. 7B illustrates a bottom perspective view of the drip tray of FIG. 7A. FIG. 7C illustrates a top perspective view of the drip tray of FIG. 7B. As shown in FIG. 7A, the beverage station can further include a drip tray system 4460 that is positioned under the dispensing points of the units 4450. As described herein, the units 4450 can be a liquid dispense or dispenser, a cup and/or lid dispense or dispenser, ice dispenser or dispense, or other types of dispensers or dispenses. Each of the dispense or dispensers can be cabinets as described herein. The drip tray system 4460 can include an outer frame 4462 that is configured to mount to a bottom surface of the unit 4450. As shown in FIG. 7C, the outer frame 4462 can have an opening 4472 through the top surface of the outer frame 4462. The outer frame 4462 can partially enclose or contain the drip tray 4464. The drip tray 4464 can be retractable, such that the drip tray 4464 can be configured to slide relative to the outer frame 4462. The drip tray 4464 can be retractable or moveable such that the drip tray 4464 can be moved between a first position and a second position. In the first position, the drip tray 4464 can be positioned beneath the dispensing point of the unit 4450. In the second position, the drip tray 4464 can be moved away from the dispense point of the unit 4450.

In some examples, the drip tray 4464 can be spring-loaded such that the drip tray 4464 remains or biased in a first position until a force is applied. When a force is applied, the drip tray 4464 can be moved into a second position. In some examples, a user can push the drip tray 4464 backwards to apply a force. This can be convenient for the user. In other examples, the drip tray 4464 can be moved in other directions, such as pushed to one side laterally or be pulled forward. The drip tray 4464 can be moved by various objects, such as a cup, a container, or a user's hand. In some examples, the drip tray 4464 can also be moved by an automated system in response to a user command or system command. The force being applied with a cup or container can advantageously allow the cup or container to then be positioned beneath the dispense point to receive the ingredient dispensed from the cabinet 4450. When the drip tray 4464 is pushed backward with a cup or container, the cup or container can be positioned underneath the dispense point of the cabinet while holding the drip tray 4464 in the second position. This allows the container to be filled with the liquid dispensed from the dispense at the dispense point.

The drip tray 4464 can be in communication with a controller or with the unit to signal that a container has been positioned in its place underneath the dispensing point of the unit 4450. The drip tray 4464 can include a sensor that prevents the unit within the cabinet 4450 from dispensing when the dispense point is covered by the drip tray 4464. For example, the integrated sensor can be a magnetic sensor that is housed in the drip tray 4464. When the drip tray 4464 is pushed backwards with the cup, the magnetic sensor positioned on the back of the drip tray 4464 can be detected with a magnet which can signal that the drip tray 4464 is in the second position, such that the drip tray 4464 has been moved away from the dispense point. In other embodiments, other types of sensors may be used to determine the location of the drip tray 4464. When the cup or container is removed and there is no force applied to the drip tray 4464, the spring-loaded mechanism can cause the drip tray 4464 to return to the first position, beneath the dispense point of the unit 4450. In this manner, any leaking or drippings from the dispense point of the unit 4450 can fall through the opening 4472 of the outer frame 4462 and into the drip tray 4464. The front surface 4468 of the drip tray 4464 can be curved. This can allow a round outer surface of the cup or container to fit against the front surface 4468 of the drip tray 4464. This makes it easier for the user to push the cup against the front surface 4468 of the drip tray 4464 for dispensing and hold the drip tray 4464 in the second position during dispensing. The drip tray 4464 can also be removed from the outer frame 4462, such as by a user pulling the drip tray 4464 forward and out from the outer frame 4462. This allows the drip tray 4464 to be emptied, such as emptied into a nearby sink.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A beverage station comprising:
a first zone positioned below a countertop;
a second zone positioned at a level of the countertop, and
a third zone positioned at an overhead level, the third zone comprising at least one reduced temperature zone.

2. The beverage station of claim 1, wherein the at least one reduced temperature zone comprises at least one refrigerated dispense, the at least one refrigerated dispense comprises an opening through a bottom surface of the least one refrigerated dispense, the opening configured to allow dispensing of an ingredient from underneath the at least one refrigerated dispense.

3. The beverage station of claim 2, wherein the at least one refrigerated dispense is mounted with an above counter support to a wall or a partition in the third zone, the above counter support comprising at least two slides to allow movement of the at least one refrigerated dispense away or towards from the wall or the partition.

4. The beverage station of claim 3, wherein the at least two slides are attached to a bottom surface of the at least one refrigerated dispense.

5. The beverage station of claim 1, further comprising a retractable drip tray configured to move between a first position positioned beneath the opening of the at least one refrigerated dispense and a second position away from the opening of the at least one refrigerated dispense.

6. The beverage station of claim 5, wherein the retractable drip tray is spring-loaded.

7. The beverage station of claim 5, wherein the retractable drip tray comprises a curved front surface.

8. The beverage station of claim 5, wherein the retractable drip tray is configured to move backwards or forwards when moving between the first position and the second position.

9. The beverage station of claim 1, wherein the first zone further comprises a cup or lid dispense.

10. The beverage station of claim 1, wherein the first zone further comprises a cabinet for storing one or more gases.

11. The beverage station of claim 10, further comprising one or more taps connected to the cabinet for storing one or more gases.

12. The beverage station of claim 1, wherein the second zone comprises the countertop and a sink.

13. The beverage station of claim 1, wherein the second zone further comprises a whip cream dispense positioned on the countertop.

14. The beverage station of claim 1, wherein the second zone further comprises at least one blender positioned on the countertop.

15. The beverage station of claim 1, wherein the second zone further comprises one or more ingredient dispenses, the one or more ingredient dispenses comprising one or more containers with pumps or scoops, wherein the one or more ingredient dispenses are positioned on the countertop.

16. The beverage station of claim 1, wherein the second zone further comprises one or more dry ingredient dispenses, the one or more dry ingredient dispenses comprising one or more containers to store dry ingredients, wherein the one or more dry ingredient dispenses are positioned on the countertop.

17. The beverage station of claim 1, wherein the third zone further comprises an ice dispense, wherein the ice dispense is an ice dispenser cabinet.

18. The beverage station of claim 1, wherein the third zone further comprises a cup or lid dispense, wherein the cup or lid dispense is a cup or lid dispenser cabinet.

19. The beverage station of claim 1, wherein the third zone further comprises one or more shelves.

20. The beverage station of claim 19, wherein the third zone further comprises a plurality of liquid dispenses, wherein the plurality of liquid dispenses comprise containers configured to dispense liquids, wherein the plurality of liquid dispenses are positioned on the one or more shelves.

21. The beverage station of claim 20, wherein the plurality of liquid containers are locked onto the one or more shelves.

22. The beverage station of claim 1, wherein the reduced temperature zone comprises a refrigerated zone or a freezer zone.

23. The beverage station of claim 1, wherein the at least one reduced temperature zone comprises an outlet for dispensing a beverage component, wherein the outlet is positioned above the countertop.

24. The beverage station of claim 1, wherein the third zone comprises a plurality of juice or tea dispenses, an ice dispense, a printer, a milk dispense, and an alternative milk dispense, and a sweet cream dispense.

25. The beverage station of claim 1, wherein the second zone comprises one or more dry ingredient dispenses, one or more blenders, one or more syrup dispenses, a sink, a whip cream dispense, and a nitro brew dispense.

26. The beverage station of claim 1, wherein the third zone comprises a plurality of juice or tea dispenses, an ice dispense, a printer, a milk dispense, and an alternative milk dispense.

27. The beverage station of claim 1, wherein the second zone comprises a plurality of dry ingredient dispenses, one or more blenders, one or more syrup dispenses, a sink, one or more sauce dispenses, a whip cream dispense, and a nitro brew dispense.

28. The beverage station of claim 1, wherein the third zone comprises a milk dispense, a plurality of alternative milk dispense, an ice dispense, and a printer.

29. The beverage station of claim 1, wherein the second zone comprises a plurality of dry ingredient dispenses, one or more blenders, one or more syrup dispenses, a sink, one or more sauce dispenses, a whip cream dispense, and a nitro brew dispense.

30. A method of forming a beverage comprising hot or cold ingredients, the method comprising:
dispensing at least one cold ingredient into a container from a location overhead.

31. The method of claim 30, wherein the at least one cold ingredient is dispensed from a reduced temperature zone.

32. The method of claim 31, wherein the reduced temperature zone comprises an ice dispense, a milk dispense, an alternative milk dispense, a tea dispense, or a juice dispense.

33. The method of claim 31, wherein the cold ingredients are only added to the container from the location overhead.
